(19) United States
(12) Patent Application Publication
(10) Pub. No.: US 2012/0180526 A1
(43) Pub. Date: Jul. 19, 2012

(54) METHOD FOR THE CORRECTIVE TREATMENT OF A DEFECT ON THE SURFACE OF AN OPTICAL COMPONENT FOR A POWER LASER

(75) Inventors: Philippe Cormont, Le Bouscat (FR); Jean-Luc Rullier, Gujan Mestras (FR); Laurent Gallais, Pertuis (FR)

(73) Assignee: COMMISSARIAT A L'ENERGIE ATOMIQUEET ENERGIES ALTERNATIVES, Paris (FR)

(21) Appl. No.: 13/496,942

(22) PCT Filed: Sep. 17, 2010
(86) PCT No.: PCT/FR2010/051939

§ 371 Date: Mar. 19, 2012

(30) Foreign Application Priority Data
Sep. 18, 2009 (FR) 0956443

(51) Int. Cl. C03B 29/00

(52) U.S. Cl. 65/29.1

(57) ABSTRACT

A method for the corrective treatment of a defect on the surface of an optical component for a power laser, includes a first step of applying a first laser beam having a power P1 for a duration t1 so as to generate an illumination E1 on a first zone, the size and position of which match the defect to be corrected, the first laser beam having a wavelength λ that can be absorbed by the material of the optical component in order to form a crater on the surface of the optical component. The method includes a second step of applying a second laser beam having a power P2 for a duration t2 on a second zone including at least the periphery of the crater created during the first step in order to subject the second zone to an illumination E2 that is lower than the illumination E1.

The present invention relates to the improvement of the laser flux resistance of optical components. It finds application in the field of optics and more particularly in the increase of service life of the optical components for power lasers.

More precisely, the invention aims to correct surface defects of optical components for power lasers. Surface defects may be present on new components: polishing defect, mechanical impact, stressed zone in the material itself. Defects may also appear during the use of such optical components in a power laser line. Indeed, the optical components of the long laser lines as the LMJ or the NIF are subjected to high laser flux that cause damages and make these damages grow, finally making the optical component unusable and leading to the necessity of replacement thereof. However, due the size of the optical components, a replacement is generally very expensive. In the last years, methods have thus appeared to limit the formation of damages or to stop damages at a stage at which they are not much developed.

The patent document WO 02/098811 describes a method for reducing the density of sites on the surface of an optical component that are liable to initiate damages during an exposure to a power laser. This method comprises steps of physicochemical preparation of the surface (mechanical polishing, magnetorheological fluid-based finishing, surface acid etching) that make it possible to reduce the density of damage initiator sites. Moreover, the method of the WO 02/098811 comprises a last step of UV laser conditioning, consisting in subjecting the optical component to a laser flux of increasing fluence to improve the resistance of the optical components to the power laser flux. Nevertheless, the step of laser conditioning may reveal or create damages, the growth of which has to be stopped. Moreover, the method described in the document WO 02/098811 does not make it possible to correct defects induced by a power laser.

The patent document US2002/0046998 proposes a method for producing more resistant optical components and for stopping the growth of damages (damage growth mitigation) on the surface of an optical component. More precisely, a first laser sweep is performed to initiate the apparition of defects on the surface of an optical component, then these defects are localized and a treatment is applied for locally or globally stopping the growth of the defects. A method for stopping the defect growth on a silica component consists in applying a CO₂ laser beam to make the material locally malleable and to anneal out the residual damage. The drawback of the CO₂ laser treatment method, as described in the US2002/0046998, is that it modifies the silica, which may lead to new damages.

The publication (“Optimization of a laser mitigation process in damaged fused silica” S. Palmier, L. Gallais, M. Commandré, P. Cormont, R. Courchinoux, L. Lamaignère, J-L Rullier, P. Legros, Applied Surface Science, 2008). doi:1016/j.apsusc.2008.07.178) shows that a method of local CO₂ laser irradiation may be efficient for stopping the damage growth in certain irradiation conditions (as a function of the pulse duration, of the laser power and of the depth of the crater created), but may also create transformations in the material that are liable to weaken the damage site.

The publication (“Mitigation of laser-damage growth in fused silica with a galvanometer scanned CO₂ laser” I. L. Bass, G. M. Guss, and R. P. Hackel in Laser-Induced Damage in Optical Materials: 2005, edited by G. J. Exarhos, A. H. Guenther, K. L. Lewis, D. Ristau, M. J. Soileau, and C. J. Stolz, Vol. 5991, p. 59910C, SPIE, Bellingham, Wash., 2006) shows that the presence of debris may be a source of new defects and proposes a passivation method for cleaning the surface from the debris. Such a passivation is performed by sweeping a CO₂ laser beam highly focused all around the first crater created by a laser irradiation. However, this latter method does not make it possible to improve enough the flux resistance of the optical surface because new damages may appear at the periphery of the zone passivated with the CO₂ laser.

The transformations caused by silica fusion under the action of the CO₂ laser may explain a flux resistance of the passivated zone lower than that of a zone without defect, as disclosed in the article “Development of a Process Model for CO₂ Laser Mitigation of Damage Growth in Fused Silica” M. D. Feit, A M Rubenchik, C D Bley, M. Rotter in Laser-Induced Damage in Optical Materials: 2003, edited by G. J. Exarhos, A. H. Guenther, K. L. Lewis, D. Ristau, M. J. Soileau, and C. J. Stolz, Vol. 5273,doi 10.1117/12.523867, SPIE, Bellingham, Wash., 2004.

The laser treatment of the damages on the surface of an optical component is interesting for extending the service life of these optical components because it makes it possible to stop the defect growth under a laser flux. However, such technic is not without risk for the optical surface because the laser flux resistance thereof is reduced with respect to a blank zone of the surface. As far as it is known, no efficient method makes it possible to stabilize the damages without impacting the flux resistance of the treated or passivated zone. Therefore, the weak zone of the optical surface creating a damage may thus be repaired, but the reparation may generate other weak zones, which are themselves liable to create damages under laser flux lower than those to which the optical components are subjected in the power laser lines.

The domain of laser-line operating lengths can range from the ultraviolet (351 nm) to the near-infrared (1053-1064 nm). A corrective treatment has therefore to make it possible to later use the optical component over the whole range of wavelengths.

No treatment method exists today making it possible to correct defects on the surface of an optical component without inducing other weaknesses, themselves liable to create damages during an exposure to a power laser flux.

The present invention aims to remedy these drawbacks and proposes a treatment method aiming to correct defects on the surface of an optical component for a power laser, so that the surface after treatment is capable of supporting a high power laser flow without generating new damages at the site of the treated defects.

The method of the invention is advantageously a contactless optical treatment.

More particularly, the invention relates to a method for the corrective treatment of a defect on the surface of an optical component for a power laser, comprising a first step of applying a first laser beam at a power P1 for a duration t1 so as to generate an illumination E₁ on a first zone, the size and position of which are adapted to the defect to be corrected, said first laser beam having a wavelength λ capable of being absorbed by the material of the optical component, in order to form a crater on the surface of the optical component. According to the invention, the method comprises a second step of applying a second laser beam at a power P2 for a duration t2 on a second zone comprising at least the periphery of the crater created during the first step, in order to subject the second zone to an illumination E₂ that is lower than the illumination E₁.

According to a particular embodiment of the method of the invention, the crater formed on the optical surface during the first step is a disc-shaped crater of diameter φ₁ and the second zone has the shape of a disc or a ring of outer diameter φ₂ greater than φ₁.

According to a particular embodiment, P1 is comprised between 1 W and 10 W, E₁ is comprised between 1 kW/cm² and 10 kW/cm², t1 and t2 are comprised between 50 ms and one second, P2 is comprised between 5 and 20 W, E₂ is comprised between 0.5 and 5 kW/cm².

According to an embodiment, the second step of the method comprises N applications of a constant illumination E₂.

According to a particular aspect of the method of the invention, the second step of the method comprises N applications of an illumination E₂, with the illumination E₂ decreasing at each application.

According to a preferred embodiment of the invention, in the first step, the laser beam is focused on the optical surface by means of an optical system and, in the second step, said optical system is axially defocused with respect to the optical surface.

According to various particular aspects of the invention:
the duration t2 is lower than the duration t1;
the variations of illumination E₂ are continuous;
the variations of illumination E₂ are discontinuous;
in the first step, the laser beam is focused on the optical surface by means of an optical system and, in the second step, said optical system is axially defocused with respect to the optical surface;
the source of the laser beams is a CO₂ laser, the wavelength λ of which is 10.6 μm;
the material of the optical component is doped or undoped silica, germanium, or alumina (Al₂O₃);
the defect is a defect due to polishing of the surface, a damage induced by exposure to a laser flux, a defect resulting from a mechanical impact, or the defect is a stressed or polluted zone.
the method further comprises a step of cleaning the surface by means of an acid solution.

The present invention also relates to the features that will appear in the following description and that will have to be considered individually or in any technically possible combination.

This description is given by way of non-limitative example and will make it possible to better understand how the invention can be implemented with reference to the appended drawings, in which:

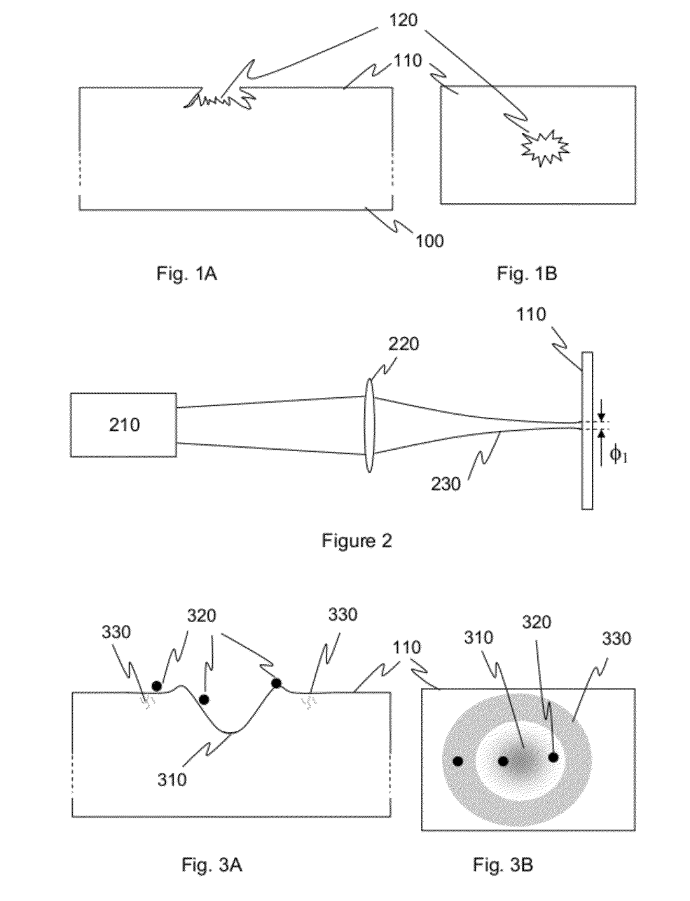

FIG. 1 shows in side (1A) and top (1B) views a defect on the surface of an optical component, which defect may grow as the exposure to the laser beam goes along;

FIG. 2 schematically shows a device for implementing the first step of the method of the invention;

FIG. 3 schematically shows in side (3A) and top (3B) views a defect site after the first step of the method of the invention;

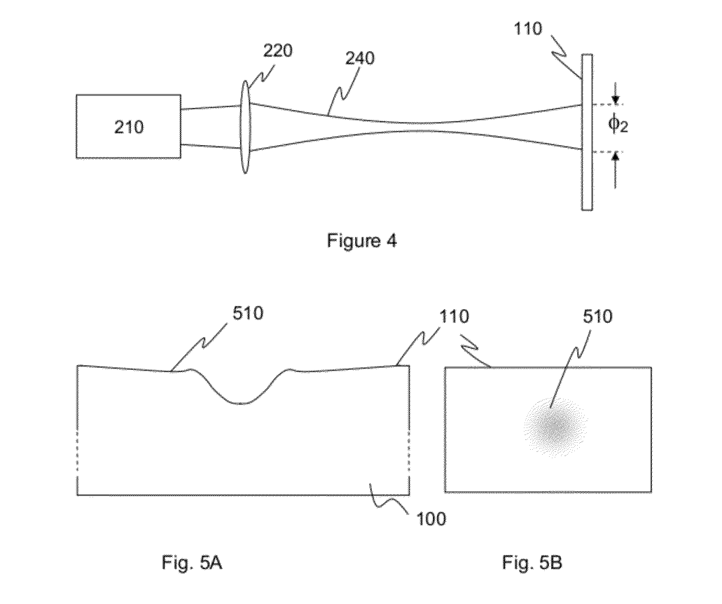

FIG. 4 schematically shows a device for implementing the second step of the method of the invention;

FIG. 5 schematically shows in side (5A) and top (5B) views a defect site at the end of the treatment method of the invention.

The optical components for power lasers may show, during their fabrication, various surface defects as, for example, a surface polishing defect. During the exposure of the optical component to a high power laser flux, this defect may initiate far more important damages, which increase as a function of the exposure to the laser flux.

Independently of a defect of fabrication of the optical component, when a power laser beam passes through or is reflected by an optical surface 110 of an optical component 100, this laser beam creates damages on the surface 110 of the optical component 100. If nothing is done to stop the damage growth, their size may increase as the exposure to the power laser flux goes along. Finally, this damage growth makes the optical component 100 unusable. It is therefore necessary to stop the damage growth to increase the service life of the optical components of a power laser line. The damage created by the laser is thus considered as a defect 120.

A preferred embodiment of the method of the invention will now be described in detail.

In a first step, schematically shown in FIG. 2, an infrared beam 230, emitted by an excitation source 210, is focused by means of a lens 220 on the defect 120 of the optical component 100. The source 210 is a CO₂ laser, which is continuous or pulsed with a repetition frequency of the order of a few kHz. The material of the optical component 100 has the property to be very little absorbing in the domain of laser-line operating lengths, but is strongly absorbing for radiations in the far infrared, such as 10.6 μm, which is the wavelength of emission of the CO₂ laser. The laser beam 230 is focused on the surface 110 and centered to the site of the defect 120, with a beam diameter φ₁ greater than the defect size, which is of a few tens of micrometers on the optical surface 110. In an exemplary embodiment, the diameter φ₁ is of the order of 200 μm. The optical component 100 strongly absorbs the energy of the beam 230, warms up and locally fuses. A part of the material is ejected.

This local re-fusion creates a crater 310 in place of the defect 120 (cf. FIG. 3). The crater diameter is for example of ˜300 microns.

This first step is successful if all the fractures of the defect have been re-fused. But generally, this first step also creates defects at the periphery of the crater 310. These defects can be debris 320 capable of being discerned by an observation with a microscope, or stresses 330 that are not visible with conventional observation means. Now, the stressed zones may spread in a peripheral zone at least equal to twice the crater diameter.

During the second step of the method, the illumination and the irradiation duration are modified. During this second step, the lens 220 is longitudinally moved so as to increase the size of the beam on the optical component, so that the diameter φ₂ of the beam 240 on the surface is greater than φ₁, while keeping the laser beam 240 centered on the site of the initial defect 120. In FIG. 4, which illustrates a device for implementing the second step of the method, the lens 220 is moved closer to the laser source 210. However, the lens 220 may be moved away from the laser source 210 to obtain the same effect. The sample 110 and the laser 210 remain stationary.

The interaction zone between the laser beam 230 and the optical component 110 is then far larger (diameter φ₂) than in the first step (diameter φ₁). The interaction zone has to include the peripheral defects (320, 330) created by the first step. The energy surface density of the laser beam 240 applied on the component 110 is lower than that of the beam 230 during the first step. Consequently, during the second step, the material of the optical component has then a lower temperature. The energy provided is sufficient to suppress the peripheral defects created during the preceding step and is of lower density so as not to generate new defects.

At the end of the method of the invention, in place of the initial defect 120, a new crater 510 is obtained, which can be subjected to high laser flux in a power laser line.

In an exemplary embodiment, P1 is of the order of 5 W, E₁ is of the order of 2.2 kW/cm², t1 and t2 are of the order of one second, P2 is of the order of 10 W, E₂ is of the order of 1.2 kW/cm².

The main advantage of the method of the invention is the improvement of service life of the laser-line optical components. This method also makes it possible to increase the laser power to which the laser-line optical components can be subjected. The other advantages of this method are its simplicity and rapidity of implementation.

The method of the invention advantageously makes it possible to use a same device for implementing the two steps required for a good reparation: stopping the damage growth and taking care of the reparation performed.

In a preferred embodiment, the second stage of the method consists in applying a laser beam 240 centered to the same site as the laser beam 230 applied during the first step. In this second stage, the laser beam 240 is then offset with respect to the defects (320, 330) induced by the first step, which are located at the periphery of the initial defect 120.

As in the previously described methods, it has been observed that the periphery of the crater created during the first step may be the source of new defects 320, 330. However, according to the previously described methods, these secondary defects was treated by re-centering a CO₂ laser beam very focused on these new defects, in the same way as the first step, in which the laser beam was centered on the initial defect. On the contrary, according the method of the invention, the laser beam is not moved between the first and the second stages, but is defocused while remaining centered on the initial defect 120, which makes it possible to obtain different results.

An application of the invention is the production of optical components for the power laser lines.

The method applies to optical components whose material may be doped or undoped silica, germanium, or alumina (Al₂O₃).

1. A method for the corrective treatment of a defect (120) on the surface (110) of an optical component (100) for a power laser, comprising a first step of:
applying a first laser beam (230) at a power P1 for a duration t1 so as to generate an illumination E₁ on a first zone, the size and position of which are adapted to the defect (120) to be corrected, said first laser beam (230) having a wavelength λ capable of being absorbed by the material of the optical component (100), in order to form a crater on the surface of the optical component (100),
characterized in that it comprises a second step of:
applying a second laser beam (240) at a power P2 for a duration t2 on a second zone comprising at least the periphery of the crater created during the first step, in order to subject the second zone to an illumination E₂ that is lower than the illumination E₁.

2. A method according to claim 1, characterized in that the crater formed on the optical surface (110) during the first step is a disc-shaped crater of diameter φ₁ and the second zone has the shape of a disc or a ring of outer diameter φ₂ greater than φ₁.

3. A method according to claim 1, characterized in that the second step comprises N applications of a constant illumination E₂.

4. A method according to claim 3, characterized in that the second step of the method comprises N applications of an illumination E₂, with the illumination E₂ decreasing at each application.

5. A method according to claim 2, characterized in that the duration t2 is lower than the duration t1.

6. A method according to claim 3, characterized in that the variations of illumination E₂ are discontinuous between two successive applications.

7. A method according to claim 3, characterized in that the variations of illumination E₂ are continuous between two successive applications.

8. A treatment method according to claim 2, characterized in that, in the first step, the laser beam (230) is focused on the optical surface (110) by means of an optical system (220) and in that, in the second step, said optical system (220) is axially defocused with respect to the optical surface (110).

9. A treatment method according to claim 1, characterized in that P1 is comprised between 1 W and 10 W, E₁ is comprised between 1 kW/cm² and 10 kW/cm², t1 and t2 are comprised between 50 ms and one second, P2 is comprised between 5 and 20 W, and E₂ is comprised between 0.5 and 5 kW/cm².

10. A treatment method according to claim 1, characterized in that the source of the laser beams (230, 240) is a CO₂ laser, the wavelength λ of which is 10.6 μm.

11. A treatment method according to claim 1, characterized in that the material of the optical component is material among the following ones: doped or undoped silica, germanium, or alumina (Al₂O₃).

12. A treatment method according to claim 1, characterized in that the defect (120) is a defect due to polishing of the surface (110), a damage induced by exposure to a laser flux, a defect resulting from a mechanical impact, or the defect (120) is a stressed or polluted zone.

13. A treatment method according to claim 1, characterized in that it further comprises a step of cleaning the surface (110) by means of an acid solution.

14. A method according to claim 2, characterized in that the second step comprises N applications of a constant illumination E₂.

15. A method according to claim 3, characterized in that the duration t2 is lower than the duration t1.

16. A method according to claim 4, characterized in that the variations of illumination E₂ are discontinuous between two successive applications.

17. A method according to claim 5, characterized in that the variations of illumination E₂ are discontinuous between two successive applications.

18. A method according to claim 4, characterized in that the variations of illumination E₂ are continuous between two successive applications.

19. A method according to claim 5, characterized in that the variations of illumination E₂ are continuous between two successive applications.
